(19) United States
(12) Patent Application Publication
(10) Pub. No.: US 2006/0272568 A1
(43) Pub. Date: Dec. 7, 2006

(54) Whistle

(76) Inventors: Christian Neidlinger, Stuttgart (DE); Mark Ital, Stuttgart (DE); Matthias Strobel, Esslingen (DE)

Correspondence Address: KRIEGSMAN & KRIEGSMAN, 30 TURNPIKE ROAD, SUITE 9, SOUTHBOROUGH, MA, 01772, US

(21) Appl. No.: 11/358,700

(22) Filed: Feb. 21, 2006

Related U.S. Application Data
(60) Provisional application No. 60/654,221, filed on Feb. 18, 2005.

(30) Foreign Application Priority Data
Feb. 18, 2005 (DE) 20 2005 002 729.4

(51) Int. Cl. G10K 5/00

(52) U.S. Cl. 116/137 R

(57) ABSTRACT

A whistle comprises a mouthpiece, a resonator and an air outlet opening. In one embodiment, a bottle opener is formed in the wall of the resonator. The bottle opener is made of a combination of a first segment shaped approximately like a quarter circle and formed in the wall of the resonator and a second segment formed as a separate component. The second segment is shaped like a metal strip. The strip is incorporated in the wall of the resonator in such a way that its outer contour follows the approximately quarter-circle contour of the first segment. Therefore, the strip projects somewhat from the surface of the first segment so that a free edge projects out from the first segment.

The present invention concerns a whistle with a mouthpiece, a resonator and an air outlet opening.

It is generally known how to combine a whistle with other useful features or functions. U.S. Pat. Nos. 5,002,006 A and 4,779,568 A disclose, for example, a whistle, which additionally has a space for holding small objects, such as keys, coins or the like, which can be closed by means of a cover. In a comparable manner, U.S. Pat. No. 4,449,474 describes a whistle, which comprises a hollow space for holding a gas cartridge. All of these whistles are conceived of as safety devices, i.e., so that the user can call for help by using the whistle in a situation in which he feels threatened.

It is also known from the international Patent Application WO 92/02341 A1 and the U.S. Pat. No. 6,619,225 B1 to integrate a whistle in a Swiss army knife in order to increase the multiple functions of the knife.

Further, it is known, for example, from the publications DE 297 07 335 U1, US 2002/0195043 A1 and U.S. Pat. No. 1,687,086 to combine a whistle with a bottle, for example, a bottle for alcoholic beverages.

The object of the present invention, when compared with the prior art, is to provide a whistle which can be used as an advertising article, and also as an article for a [sports] fan.

The solution consists of a whistle, which is provided with a bottle opener according to the invention. Such a whistle can be used in many ways as an advertising item, e.g., as a prize in the purchase of beverage bottles with crown corks or as an advertising gift from a producer of beverages in bottles provided with crown corks, a producer who is also a sponsor of events, in particular sporting events. In this connection, it can also be used as an article for [sports] fans. The whistle according to the invention is simple to produce, handy, useful in two ways and thus is an ideal advertising article.

Advantageous enhancements result from the subclaims.

The bottle opener is preferably integrated into a wall, for example, into a wall of the resonator of the whistle. Thus the whistle according to the invention is particularly handy. For example, the bottle opener can be incorporated in one piece in a wall of the whistle, which simplifies the production of the whistle according to the invention.

Another advantageous enhancement of the whistle according to the invention provides that the bottle opener is formed as a separate component. The bottle opener, however, can also be the combination of a segment formed in one piece in a wall of the whistle and a segment formed as a separate component. In this way there is a greater variability of shape for the bottle opener, on the one hand, and the whistle according to the invention, on the other hand, so that the configuration can be optimally adapted to the wish, for example, of an advertiser or sponsor.

The separate component can be shaped, for example, as a bent strip or as a profiled part, for purposes of ease of holding, preferably from metal and/or plastic. The separate component is incorporated in a wall of the whistle, for example, and preferably has at least one projecting edge for optimizing the function.

The mouthpiece and/or the resonator of the whistle according to the invention can be a combination of at least two parts, wherein one of the parts can be a removable cover. This simplifies the production and makes it possible to provide at least one hollow space for storage of smaller objects, in a way known in and of itself, for example, in the resonator. In addition, the mouthpiece and/or the resonator is (are) preferably made of plastic, so that they are simple to produce, for example, in the injection-molding process.

The present invention will now be explained in more detail in the following on the basis of the attached drawings. Herein is shown:

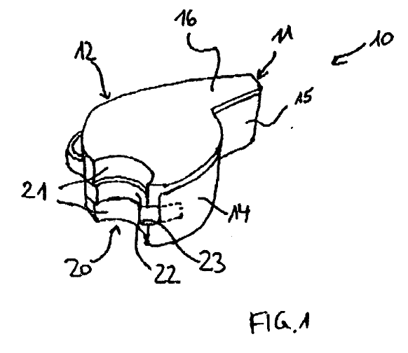

FIG. 1: a perspective view of a first example of embodiment of a whistle according to the invention in a schematic representation that is not of correct scale;

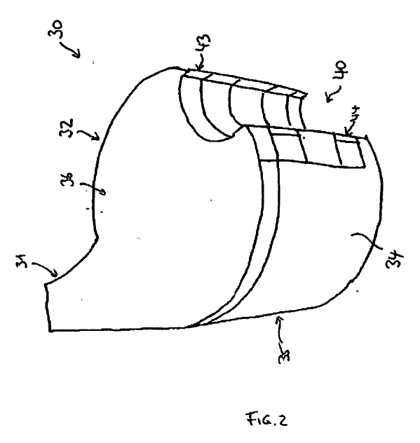

FIG. 2: a perspective view of a second example of embodiment of a whistle according to the invention in a schematic representation that is not of correct scale;

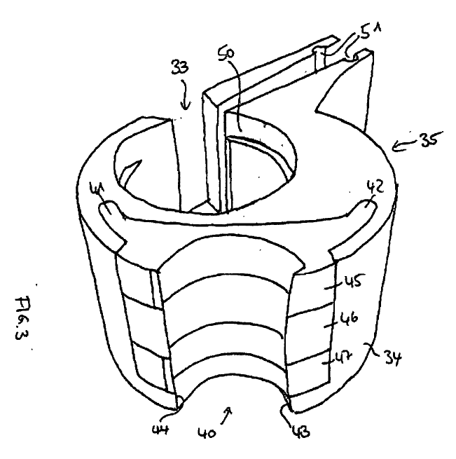

FIG. 3: a perspective view of the first component of the whistle according to FIG. 2 in a schematic representation that is not of correct scale;

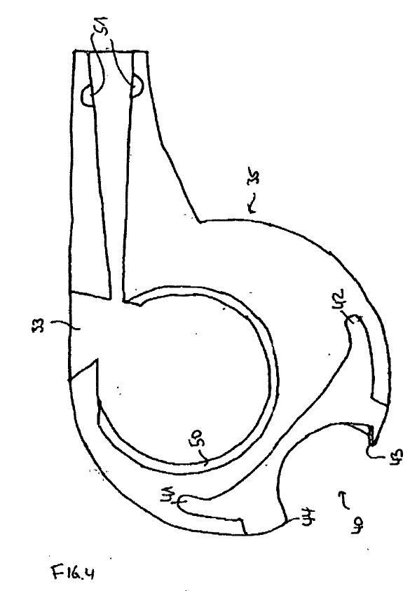

FIG. 4: the first component according to FIG. 3 in a top view;

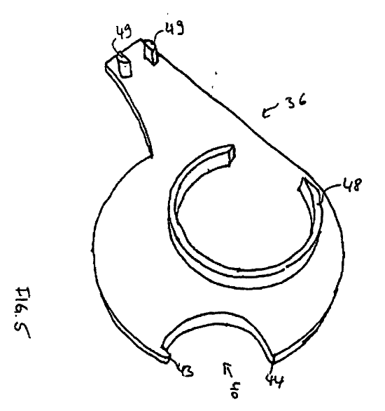

FIG. 5: a perspective view of the second component of the whistle according to FIG. 2 in a schematic representation that is not of correct scale;

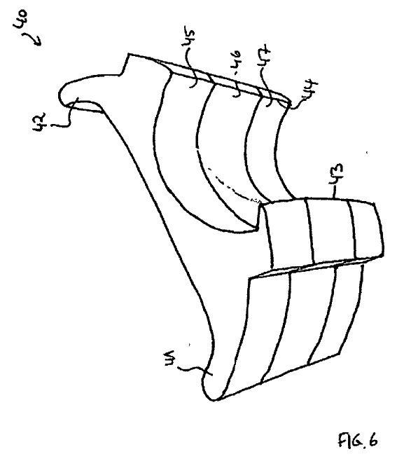

FIG. 6: a perspective view of the bottle opener of the whistle according to FIG. 2 in a schematic representation that is not of correct scale.

FIG. 1 shows a first example of embodiment of a whistle 10 according to the invention with a mouthpiece 11, a resonator 12 and an air outlet opening (not shown). A bottle opener 20 is formed in the wall 14 of the resonator 12. The bottle opener 20 in the example of embodiment is made of a combination of a first segment 21 shaped approximately like a quarter circle and formed in the wall 14 of the resonator 12 and a second segment 22 formed as a separate component. The second segment is shaped like a metal strip 22 in the example of embodiment. The strip 22 is incorporated in wall 14 of resonator 12 in such a way that its outer contour follows the approximately quarter-circle contour of the first segment 21. Therefore, strip 22 projects somewhat, however, from the surface of the first segment 21, so that s free edge 23 projects out from the first segment 21.

In the example of embodiment, mouthpiece 11 and resonator 12 are produced from plastic in an injection-molding process. Mouthpiece 11 and resonator 12 are made of a combination of a first component 15 and a second component 16, which surround metal strip 22.

FIGS. 2 to 6 show a second example of embodiment of a whistle 30 according to the invention with a mouthpiece 31, a resonator 32 and an air outlet opening (33). A bottle opener 40 is incorporated in the wall 34 of the resonator 32. In the example of embodiment, bottle opener 40 is a separate component, which is inserted flush into the wall 34 of the resonator 32. Bottle opener 40 is made of a combination of one to three layers (45, 46, 47), which, depending on the requirement in the individual case, can be selectively made of plastic or metal. The bottle opener 40 in the example of embodiment is a diecast part made of metal. However, it can also be a plastic part produced by extrusion, for example. The bottle opener 40 has two free edges 43, 44 in its outer contour in order to optimize functionality. Further, it is provided with two projections 41, 42 on its side facing the resonator 32, and these projections serve for the purpose of holding the bottle opener 40 in resonator 32, secure against loss, and absorbing the torque that arises when a bottle is opened with bottle opener 40.

In the example of embodiment, mouthpiece 31 and resonator 32 are produced from plastic in an injection-molding process. Mouthpiece 31 and resonator 32 are a combination of a first component, namely a housing 35, and a second component, namely a cover 36. Bottle opener 40 is incorporated in the housing 35 in the example of embodiment. The cover 36, in the example of embodiment, has holding elements 48, 49, which engage with corresponding recesses in housing 35, so that the cover 36 is held by fitting precisely onto housing 35. Then the cover 36 can be correctly positioned and subsequently rigidly joined to housing 35, for example, by ultrasonic welding. Both housing 35 and cover 36 are shaped in such a way that they have a recess that is shaped approximately as a quarter-circle in the region in which bottle opener 40 is found, and this recess corresponds to the outer contours of bottle opener 40.

Of course, cover 36 can also be formed so that it can be removed. For example, one or more hollow spaces can be provided in housing 35 in a way known in and of itself, for receiving smaller objects.

1. A whistle with a mouthpiece a resonator and an air outlet opening is hereby characterized in that it is provided with a bottle opener.

2. The whistle according to claim 1, further characterized in that the bottle opener is integrated into a wall, preferably a wall of the resonator of the whistle.

3. The whistle according to claim 2, further characterized in that the bottle opener is shaped in one piece in a wall of the whistle.

4. The whistle according to claim 1, further characterized in that the bottle opener is formed at least partially as a separate component.

5. The whistle according to claim 2, further characterized in that the bottle opener is a combination of a segment formed in one piece in a wall of the whistle and a segment formed as a separate component.

6. The whistle according to claim 4, further characterized in that the separate component is formed as a bent strip or as a profiled part.

7. The whistle according to claim 6, further characterized in that the bent strip or the profiled part is comprised of metal and/or plastic.

8. The whistle according to claim 4, further characterized in that the separate component is incorporated in a wall of whistle.

9. The whistle according to claim 4, further characterized in that the separate component has at least one projecting free edge.

10. The whistle according to claim 4, further characterized in that the mouthpiece and/or the resonator is a combination of at least two parts.

11. The whistle according to claim 10, further characterized in that one of the parts is shaped as a removable cover.

12. The whistle according to claim 1, further characterized in that the mouthpiece and/or the resonator is comprised of plastic.
